(19) United States
(12) Patent Application Publication
(10) Pub. No.: US 2023/0100631 A1
(43) Pub. Date: Mar. 30, 2023

(54) Nonaqueous Electrolyte Solution and Lithium Secondary Battery Comprising the Same

(71) Applicant: LG Energy Solution, Ltd., Seoul (KR)

(72) Inventors: Yoshiyuki Igarashi, Tokyo (JP); Keiko Matsubara, Tokyo (JP)

(73) Assignee: LG Energy Solution, Ltd., Seoul (KR)

(21) Appl. No.: 17/788,543

(22) PCT Filed: Dec. 24, 2020
(86) PCT No.: PCT/KR2020/019152

§ 371 Date: Jun. 23, 2022

(30) Foreign Application Priority Data
Dec. 25, 2019 (JP) 2019-235040

(51) Int. Cl. H01M 10/0567; H01M 4/48; H01M 4/525

(52) U.S. Cl. CPC H01M 10/0567; H01M 4/483; H01M 4/525; H01M 10/0525

(57) ABSTRACT

The present disclosure is directed to providing an electrolyte solution with a long cycle life by suppressing degradation of the battery characteristics under the high temperature condition. There is provided a nonaqueous electrolyte solution comprising a compound comprising 5 to 20 mass % of nitrogen atoms and 25 to 70 mass % of sulfur atoms or oxygen atoms in a molecule and having no disulfide bond in the molecule, wherein the compound comprises at least two sulfur atoms or oxygen atoms in the molecule.

### CROSS-REFERENCE TO RELATED APPLICATIONS

The present application is a national stage entry under 35 U.S.C. § 371 of International Application No. PCT/KR2020/019152 filed on Dec. 24, 2020, which claims priority from Japanese Patent Application No. 2019-235040 filed on Dec. 25, 2019, all the disclosures of which are incorporated herein by reference.

### TECHNICAL FIELD

The present disclosure relates to a nonaqueous electrolyte solution and a lithium secondary battery comprising the same.

### BACKGROUND ART

Lithium secondary batteries are widely used as storage batteries for not only portable devices such as mobile phones or laptop computers, but also vehicles and industrial applications, and even in new applications such as drones. The lithium secondary batteries have comparatively higher energy density than other types of secondary batteries, but to manufacture lithium secondary batteries having higher energy density, the use of a material comprising nickel as a positive electrode active material is contemplated.

Lithium cobalt oxide (LCO) has been used as the positive electrode active material of the lithium secondary battery, but nickel-cobalt-manganese (NCM) comprising nickel is increasingly used. Additionally, the use of a nickel-cobalt-aluminum (NCA) ternary material is contemplated. Such a ternary material has an advantage in terms of high energy density as well as cost competition, lowering the cobalt use.

Additionally, there is an ongoing development for the use of a material comprising silicon as a negative electrode active material. Since the material comprising silicon has a high theoretical capacity, there is a high expectation especially for the use in automotive applications requiring high capacity.

When the positive electrode active material and the negative electrode active material are used as described above, an optimal electrolyte solution is contemplated. It is known that among materials included in the electrolyte solution, trace water affects electrolyte degradation. For example, when LiPF₆ is used as an electrolyte, the following reaction occurs and the electrolyte decomposes, producing acid content.

LiPF₆+H₂O→LiF+POF₃+2HF

It is known that the produced acid content reacts with the surface of the negative electrode material comprising silicon, such as SiO, or a layer formed on the surface, which in turn increases the impedance and degrades the battery characteristics. Additionally, when the material comprising nickel is used as the positive electrode active material, a large amount of alkali remains in the material, and may accelerate the reaction producing acid.

Patent Literature 1 discloses using a nonaqueous electrolyte comprising boric acid triester to improve the high temperature storage characteristics and cycle characteristics of the lithium secondary battery. However, Patent Literature 1 discloses reducing the influence on OH—, but does not disclose the influence on acid.

Patent Literature 2 discloses using electrolyte comprising a specific silicon containing compound to improve the life and high temperature stability of the lithium secondary battery. However, the silicon containing compound is usually difficult to prepare, and its utility is not known.

Patent Literature 3 discloses a nonaqueous electrolyte solution comprising at least one type of additive selected from the group consisting of compounds comprising nitrogen atoms having lone pairs to prevent the production of hydrogen fluoride by using specific fluorinated acrylate as an electrolyte composition. However, Patent Literature 3 proves that it is effective when graphite is used as the negative electrode, but does not address the influence on the negative electrode and the layer on the surface when the material comprising silicon is used.

### RELATED LITERATURES

### Patent Literatures

Patent Literature 1: Japanese Patent Publication No. 2019-40701

Patent Literature 2: Japanese Patent Publication No. 2019-71302

Patent Literature 3: Japanese Patent Publication No. 2019-186078

### DISCLOSURE

### Technical Problem

Accordingly, there is a need for an electrolyte solution with the outstanding battery characteristics and cycle life by stabilizing the electrolyte solution characteristics even in case that a nickel containing material is used in a positive electrode and a silicon containing material is used in a negative electrode.

The present disclosure is designed to solve the above-described problem of the conventional art, and therefore the present disclosure is directed to providing an electrolyte solution with a long cycle life by suppressing degradation of the battery characteristics under the high temperature condition.

### Technical Solution

After carefully reviewing the above-described problem, unexpectedly, the inventors found that when a compound comprising specific amounts of nitrogen atoms and sulfur atoms or oxygen atoms and having no disulfide bond in a molecule is used as an additive of an electrolyte solution, it is possible to maintain high capacity density under the high temperature condition, and arrived at the invention.

The object of the present disclosure is achieved by a nonaqueous electrolyte solution comprising a compound comprising 5 to 20 mass % of nitrogen atoms and 25 to 70 mass % of sulfur atoms or oxygen atoms in a molecule and having no disulfide bond in the molecule, wherein the compound comprises at least two sulfur atoms or oxygen atoms in the molecule.

The compound may be a compound comprising 5 to 20 mass % of nitrogen atoms and 25 to 70 mass % of sulfur atoms in the molecule and having no disulfide bond in the molecule.

The compound may comprise at least two sulfur atoms in the molecule.

The compound may comprise at least three sulfur atoms in the molecule.

The compound may comprise at least one of compounds represented by the following chemical formulas 1 to 3:

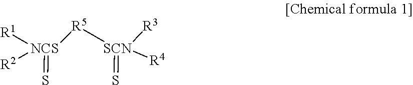

where R₁ is an alkyl group having 1 to 18 carbon atoms or phenyl group, R₂ is an alkyl group having 1 to 18 carbon atoms or phenyl group, R₃ is an alkyl group having 1 to 18 carbon atoms or phenyl group, R₄ is an alkyl group having 1 to 18 carbon atoms or phenyl group, and R₅ is an alkylene group having 1 to 12 carbon atoms,

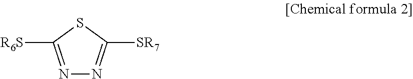

where R₆ is hydrogen, or an alkyl group having 1 to 18 carbon atoms, R₇ is hydrogen, or an alkyl group having 1 to 18 carbon atoms,

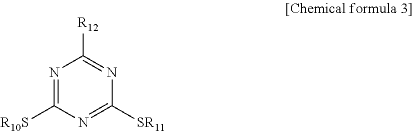

where R₁₀ is hydrogen, or an alkyl group having 1 to 18 carbon atoms, R₁₁ is hydrogen, or an alkyl group having 1 to 18 carbon atoms, R₁₂ is —SR₁₅ or —N(R₁₆)(R₁₇), R₁₅ is hydrogen, or an alkyl group having 1 to 18 carbon atoms, and each of Rib and Rig is independently a substituted or unsubstituted alkyl group having 1 to 18 carbon atoms.

The compound may comprise at least one of bis(diethylthiocarbamate)methylene, bis(diethyldithiocarbamate)ethylene, bis(dipropylthiocarbamate)methylene, bis(dipropyldithiocarbamate)ethylene, bis(dibutyldithiocarbamate)methylene, bis(dibutyldithiocarbamate)ethylene, bis(dipentyldithiocarbamate)methylene, bis(dipentyldithiocarbamate)ethylene, bis(dihexyldithiocarbamate)methylene, bis(dihexyldithiocarbamate)ethylene 2,5-dimercapto-1,3,4-thiadiazole, 1,3,5-Triazine-2,4,6-trithiol, 2-(Dibutylamino)-1,3,5-Triazine-4,6-dithiol, 6-(Diisopropylamino)-1,3,5-triazine-2,4-dithiol, 6-(Diisobutylamino)-1,3,5-triazine-2,4-dithiol, 6-Diallylamino-1,3,5-triazine-2,4-dithiol or 6-Di(2-ethylhexyl)amino-1,3,5-triazine-2,4-dithiol.

The compound may comprise at least one of the compound represented by the chemical formula 1 or the compound represented by the chemical formula 3.

The compound may comprise at least one of bis(diethylthiocarbamate)methylene, bis(diethyldithiocarbamate)ethylene, bis(dipropylthiocarbamate)methylene, bis(dipropyldithiocarbamate)ethylene, bis(dibutyldithiocarbamate)methylene, bis(dibutyldithiocarbamate)ethylene, bis(dipentyldithiocarbamate)methylene, bis(dipentyldithiocarbamate)ethylene, bis(dihexyldithiocarbamate)methylene, bis(dihexyldithiocarbamate)ethylene, 1,3,5-Triazine-2,4,6-trithiol, 2-(Dibutylamino)-1,3,5-Triazine-4,6-dithiol, 6-(Diisopropylamino)-1,3,5-triazine-2,4-dithiol, 6-(Diisobutylamino)-1,3,5-triazine-2,4-dithiol, 6-Diallylamino-1,3,5-triazine-2,4-dithiol or 6-Di(2-ethylhexyl)amino-1,3,5-triazine-2,4-dithiol.

The compound may be included in an amount of 0.1 to 1 mass % based on the total mass of the nonaqueous electrolyte solution.

The nonaqueous electrolyte solution of the present disclosure may further comprise a cyclic carbonate and a chain carbonate.

The nonaqueous electrolyte solution of the present disclosure may further comprise a lithium salt, and the lithium salt may be LiPF₆.

Additionally, the present disclosure relates to a lithium secondary battery comprising a positive electrode, a negative electrode, and the nonaqueous electrolyte solution of the present disclosure interposed between the positive electrode and the negative electrode.

The positive electrode may comprise a nickel-cobalt-manganese (NCM) or nickel-cobalt-aluminum (NCA) ternary material.

The negative electrode may comprise a material comprising silicon.

An initial capacity density per the positive electrode may be 185 mAh/g or more.

### Advantageous Effects

According to the present disclosure, it is possible to provide an electrolyte solution with a long cycle life, in which a compound comprising 5 to 20 mass % of nitrogen atoms and 25 to 70 mass % of sulfur atoms or oxygen atoms in a molecule and having no disulfide bond in the molecule is used as an additive of a nonaqueous electrolyte solution, to prevent acid production when water infiltrates into a lithium secondary battery, thereby suppressing degradation of the battery characteristics under the high temperature condition.

### BRIEF DESCRIPTION OF THE DRAWINGS

FIG. 1 is a graph showing a relationship between cycle number and capacity obtained as a result of charge/discharge cycle test of Examples 1 and 2 and Comparative example 1.

FIG. 2 is a graph showing a relationship between cycle number and capacity obtained as a result of charge/discharge cycle test of Examples 3 and 4 and Comparative example 1.

FIG. 3 is a graph showing a relationship between cycle number and capacity obtained as a result of charge/discharge cycle test of Examples 5 and 6 and Comparative example 1.

FIG. 4 is a graph showing a relationship between cycle number and capacity obtained as a result of charge/discharge cycle test of Examples 7 and 8 and Comparative example 1.

FIG. 5 is a graph showing a relationship between storage period and capacity obtained as a result of high temperature storage test of Examples 3 and 4 and Comparative example 1.

FIG. 6 is a graph showing a relationship between storage period and capacity obtained as a result of high temperature storage test of Examples 5 and 6 and Comparative example 1.

FIG. 7 is a graph showing a relationship between storage period and capacity obtained as a result of high temperature storage testing of Examples 7 and 8 and Comparative example 1.

### DETAILED DESCRIPTION

A nonaqueous electrolyte solution of the present disclosure comprises a compound comprising 5 to 20 mass % of nitrogen atoms and 25 to 70 mass % of sulfur atoms or oxygen atoms in a molecule and having no disulfide bond in the molecule as an additive.

The compound as the additive included in the nonaqueous electrolyte solution of the present disclosure may be a compound 5 to 20 mass % of nitrogen atoms and 25 to 70 mass % of sulfur atoms in a molecule and having no disulfide bond in the molecule, and a compound comprising 5 to 20 mass % of nitrogen atoms and 25 to 70 mass % of oxygen atoms in a molecule and having no disulfide bond in the molecule. The compound comprising 5 to 20 mass % of nitrogen atoms and 25 to 70 mass % of sulfur atoms in a molecule and having no disulfide bond in the molecule is desirable.

A mass ratio of the nitrogen atoms and the sulfur atoms or the oxygen atoms in the molecule of the compound is not specifically limited to, but is preferably 5:1 to 1:10, more preferably 2:1 to 1:8 and most preferably 1:1 to 1:6.

Additionally, the compound comprises at least two or three sulfur atoms or oxygen atoms in the molecule, and may comprise at least two or three sulfur atoms in the molecule and may comprise at least two or three oxygen atoms in the molecule. Preferably, the compound comprises at least two or three sulfur atoms in the molecule.

In an embodiment, the compound as the additive included in the nonaqueous electrolyte solution of the present disclosure may comprise compounds represented by the following chemical formulas 1 to 3 alone or in combination of the two or more:

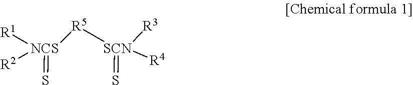

where R₁ is an alkyl group having 1 to 18 carbon atoms or phenyl group, R₂ is an alkyl group having 1 to 18 carbon atoms or phenyl group, R₃ is an alkyl group having 1 to 18 carbon atoms or phenyl group, R₄ is an alkyl group having 1 to 18 carbon atoms or phenyl group, and R₅ is an alkylene group having 1 to 12 carbon atoms,

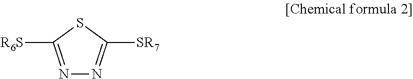

where R₆ is hydrogen, or an alkyl group having 1 to 18 carbon atoms, R₇ is hydrogen, or an alkyl group having 1 to 18 carbon atoms,

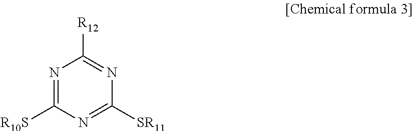

where R₁₀ is hydrogen, or an alkyl group having 1 to 18 carbon atoms, R₁₁ is hydrogen, or an alkyl group having 1 to 18 carbon atoms, R₁₂ is —SR₁₅ or —N(R₁₆)(R₁₇), R₁₅ is hydrogen, or an alkyl group having 1 to 18 carbon atoms, and each of Rib and Rig is independently a substituted or unsubstituted alkyl group having 1 to 18 carbon atoms.

In the above chemical formula 1, R₁ is preferably an alkyl group having 1 to 18 carbon atoms, and more preferably an alkyl group having 2 to 12 carbon atoms. R₂ is preferably an alkyl group having 1 to 18 carbon atoms, and more preferably an alkyl group having 2 to 12 carbon atoms. R₃ is preferably an alkyl group having 1 to 18 carbon atoms, and more preferably an alkyl group having 2 to 12 carbon atoms. R₄ is preferably an alkyl group having 1 to 18 carbon atoms, and more preferably an alkyl group having 2 to 12 carbon atoms. Additionally, R₁ to R₄ are preferably the same.

In the above chemical formula 1, R₅ is preferably an alkylene group having 1 to 6 carbon atoms, and more preferably an alkylene group having 1 to 3 carbon atoms.

In the above chemical formula 2, R₆ is preferably hydrogen, or an alkyl group having 1 to 18 carbon atoms, and more preferably hydrogen, or an alkyl group having 2 to 12 carbon atoms. R₇ is preferably hydrogen, or an alkyl group having 1 to 18 carbon atoms, and more preferably hydrogen, or an alkyl group having 2 to 12 carbon atoms.

In the above chemical formula 3, R₁₀ is preferably hydrogen, or an alkyl group having 1 to 18 carbon atoms, and more preferably hydrogen, or an alkyl group having 2 to 12 carbon atoms. R₁₁ is preferably hydrogen, or an alkyl group having 1 to 18 carbon atoms, and more preferably hydrogen, or an alkyl group having 2 to 12 carbon atoms. R₁₂ is —SR₁₅ or —N(R₁₆)(R₁₇), and in this instance, R₁₅ is hydrogen, or an alkyl group having 1 to 18 carbon atoms, and preferably, each of R₁₆ and R₁₇ is independently a substituted or unsubstituted alkyl group having 1 to 18 carbon atoms, and preferably R₁₂ is a thio group, an alkylthio group having 2 to 12 carbon atoms, a dialkyl amino group having 2 to 12 carbon atoms, a diallylalkylamino group having 2 to 12 carbon atoms.

The compound represented by the above chemical formula 1 may include bis(diethylthiocarbamate)methylene, bis(diethyldithiocarbamate)ethylene, bis(dipropylthiocarbamate)methylene, bis(dipropyldithiocarbamate)ethylene, bis(dibutyldithiocarbamate)methylene, bis(dibutyldithiocarbamate)ethylene, bis(dipentyldithiocarbamate)methylene, bis(dipentyldithiocarbamate)ethylene, bis(dihexyldithiocarbamate)methylene, bis(dihexyldithiocarbamate)ethylene.

In an embodiment, the compound as the additive included in the nonaqueous electrolyte solution of the present disclosure is preferably a thiadiazole compound represented by the above chemical formula 2. The thiadiazole compound represented by the above chemical formula 2 preferably includes 2,5-dimercapto-1,3,4-thiadiazole or its derivatives.

Preferably, the compound as the additive included in the nonaqueous electrolyte solution of the present disclosure is bis(dibutyldithiocarbamate)methylene or 2,5-dimercapto-1,3,4-thiadiazole.

Additionally, a triazine-based compound represented by the above chemical formula 3 may include 1,3,5-Triazine-2,4,6-trithiol, 2-(Dibutylamino)-1,3,5-Triazine-4,6-dithiol, 6-(Diisopropylamino)-1,3,5-triazine-2,4-dithiol, 6-(Diisobutylamino)-1,3,5-triazine-2,4-dithiol, 6-Diallylamino-1,3,5-triazine-2,4-dithiol, 6-Di(2-ethylhexyl)amino-1,3,5-triazine-2,4-dithiol.

The compound as the additive included in the nonaqueous electrolyte solution of an embodiment of the present disclosure may include at least one of the compound represented by the above chemical formula 1 or the compound represented by the above chemical formula 3.

The compound represented by the above chemical formula 1 has higher stability (lower acid content) of the electrolyte solution than the compound represented by the above chemical formula 2, and the compound represented by the above chemical formula 3 is easy to synthesize and introduce substituents, and thus is more advantageous than the compound represented by the above chemical formula 2.

The compound may comprise at least one of bis(diethylthiocarbamate)methylene, bis(diethyldithiocarbamate)ethylene, bis(dipropylthiocarbamate)methylene, bis(dipropyldithiocarbamate)ethylene, bis(dibutyldithiocarbamate)methylene, bis(dibutyldithiocarbamate)ethylene, bis(dipentyldithiocarbamate)methylene, bis(dipentyldithiocarbamate)ethylene, bis(dihexyldithiocarbamate)methylene, bis(dihexyldithiocarbamate)ethylene, 1,3,5-Triazine-2,4,6-trithiol, 2-(Dibutylamino)-1,3,5-Triazine-4,6-dithiol, 6-(Diisopropylamino)-1,3,5-triazine-2,4-dithiol, 6-(Diisobutylamino)-1,3,5-triazine-2,4-dithiol, 6-Diallylamino-1,3,5-triazine-2,4-dithiol or 6-Di(2-ethylhexyl)amino-1,3,5-triazine-2,4-dithiol.

The compound as the additive included in the nonaqueous electrolyte solution of the present disclosure is preferably included in an amount of 0.1 to 1 mass %, more preferably 0.2 to 0.9 mass % and most preferably 0.3 to 0.8 mass % based on the total mass of the nonaqueous electrolyte solution. When the compound as the additive is included in an amount within the above-described range, it is possible to effectively suppress the reaction producing acid in the battery.

The compound as the additive included in the nonaqueous electrolyte solution of the present disclosure may be used alone or in combination. When used in combination, the sum of amounts is preferably within the above-described range.

Preferably, the nonaqueous electrolyte solution of the present disclosure further comprises an organic solvent, for example, a cyclic carbonate, a chain carbonate, an ether compound, an ester compound and an amide compound. These organic solvents may be used alone or in combination. Preferably, the nonaqueous electrolyte solution of the present disclosure comprises a cyclic carbonate and a chain carbonate as the organic solvent.

The cyclic carbonate may include at least one of ethylene carbonate (EC), propylene carbonate (PC), vinylene carbonate (VC), methylvinylene carbonate, ethylvinylene carbonate, 1,2-diethylvinylene carbonate, vinylethylene carbonate (VEC), 1-methyl-2-vinylethylene carbonate, 1-ethyl-2-vinylethylene carbonate, 1-methyl-2-vinylethylene carbonate, 1,1-divinylethylene carbonate, 1,2-divinylethylene carbonate, 1,1-dimethyl-2-methyleneethylene carbonate, 1,1-diethyl-2-methyleneethylene carbonate, ethynylethylene carbonate, 1,2-diethynylethylene carbonate, 1,2-butylene carbonate, 2,3-butylene carbonate, 1,2-pentylene carbonate, 2,3-pentylene carbonate or chloro ethylene carbonate. Additionally, the chain carbonate may include at least one of dimethyl carbonate (DMC), ethyl methyl carbonate (EMC), methyl propyl carbonate (MPC), methyl isopropyl carbonate, methyl butyl carbonate, diethyl carbonate (DEC), ethyl propyl carbonate, ethyl butyl carbonate, dipropyl carbonate or propyl butyl carbonate.

The cyclic carbonate may comprise a cyclic carbonate comprising fluorine atoms. The cyclic carbonate comprising fluorine atoms may include at least one of fluoro vinylene carbonate, trifluoro methylvinylene carbonate, fluoro ethylene carbonate, 1,2-difluoro ethylene carbonate, 1,1-difluoro ethylene carbonate, 1,1,2-trifluoro ethylene carbonate, tetrafluoroethylene carbonate, 1-fluoro-2-methyl ethylene carbonate, 1-fluoro-1-methyl ethylene carbonate, 1,2-difluoro-1-methyl ethylene carbonate, 1,1,2-trifluoro-2-methyl ethylene carbonate, trifluoro methyl ethylene carbonate, 4-fluoro-1,3-dioxolane-2-one, trans or cis 4,5-difluoro-1,3-dioxolane-2-one or 4-ethynyl-1,3-dioxolane-2-one.

In particular, among the carbonates, the cyclic carbonate such as ethylene carbonate and propylene carbonate is a high viscosity organic solvent, and since the cyclic carbonate has a high dielectric constant and easily dissociates a lithium salt in electrolyte, it is desirable to use it, and preferably, when the cyclic carbonate is mixed with the chain carbonate having low viscosity and low dielectric constant such as dimethyl carbonate, diethyl carbonate and ethyl methyl carbonate at an optimal ratio, it is possible to prepare an electrolyte solution having high electrical conductivity.

The nonaqueous electrolyte solution of the present disclosure may further comprise an ether compound such as a cyclic ether or a chain ether. Examples of the cyclic ether may include tetrahydrofuran and 2-methyl tetrahydrofuran. Additionally, the nonaqueous electrolyte solution of the present disclosure may further comprise a chain ether. Examples of the chain ether may include dimethyl ether, diethyl ether, dipropyl ether, methyl ethyl ether, methyl propyl ether and ethyl propyl ether.

The nonaqueous electrolyte solution of the present disclosure may further comprise an ester compound such as carboxylic ester. The examples of the carboxylic ester may include at least one of methyl formate, ethyl formate, methyl acetate, ethyl acetate, propyl acetate, butyl acetate, methyl propionate, ethyl propionate, propyl propionate, methyl butyrate, ethyl butyrate, propyl butyrate, methyl valerate, ethyl valerate, propyl valerate, γ-butyrolactone, γ-valerolactone, γ-caprolactone, σ-valerolactone, ε-caprolactone or compounds with partial substitution of fluorine for hydrogen of these carboxylic esters.

In addition to the foregoing, the nonaqueous electrolyte solution of the present disclosure may comprise any type of other solvent, for example, poly ether, a sulfur containing solvent and a phosphorous containing solvent, without departing from the purpose of the present disclosure.

The nonaqueous electrolyte solution of the present disclosure may comprise a mixture of cyclic carbonate and chain carbonate, and a ratio of the cyclic carbonate and the chain carbonate is preferably 1:9 to 9:1 at a volume ratio, and more preferably 2:8 to 8:2 at a volume ratio.

The nonaqueous electrolyte solution of the present disclosure may comprise an electrolyte commonly used in secondary batteries. The electrolyte acts as a medium that transports an ion involved in the electrochemical reaction in a secondary battery. In particular, the present disclosure is useful as an electrolyte solution for a lithium secondary battery, and in this case, comprises a lithium salt as an electrolyte.

The lithium salt included in the nonaqueous electrolyte solution of the present disclosure may include, for example, LiPF₆, LiBF₄, LiB₁₂F₁₂, LiAsF₆, LiFSO₃, Li₂SiF₆, LiCF₃CO₂, LiCH₃CO₂, LiCF₃SO₃, LiC₄F₉SO₃, LiCF₃CF₂SO₃, LiCF₃(CF₂)₇SO₃, LiCF₃CF₂(CF₃)₂CO, Li(CF₃SO₂)₂CH, LiNO₃, LiN(CN)₂, LiN(FSO₂)₂, LiN(F₂SO₂)₂, LiN(CF₃SO₂)₂, LiN(C₂F₅SO₂)₂, LiC(CF₃SO₂)₃, LiP(CF₃)₆, LiPF(CF₃)₅, LiPF₂(CF₃)₄, LiPF₃(CF₃)₃, LiPF₄(CF₃)₂, LiPF₄(C₂F₅)₂, LiPF₄(CF₃SO₂)₂, LiPF₄(C₂F₅SO₂)₂, LiBF₂C₂O₄, LiBC₄O₈, LiBF₂(CF₃)₂, LiBF₂(C₂F₅)₂, LiBF₂(CF₃SO₂)₂, LiBF₂(C₂F₅SO₂)₂, LiSbF₆, LiAlO₄, LiAlF₄, LiSCN, LiClO₄, LiCl, LiF, LiBr, LiI, and LiAlCl₄. In particular, the lithium salt is preferably an inorganic salt such as LiPF₆, LiBF₄, LiAsF₆ and LiClO₄. The lithium salt may be used alone or in combination.

The electrolyte is not specifically limited to, but is included in an amount of 0.1 mol/L to 5 mol/L or less, preferably 0.5 mol/L to 3 mol/L or less, more preferably 0.5 mol/L to 2 mol/L or less based on the total mass of the nonaqueous electrolyte solution. When the amount of electrolyte is in the above-described range, sufficient battery characteristics may be obtained.

The nonaqueous electrolyte solution of the present disclosure may comprise at least one type of other additive. The other additive may include a flame retardant, a wetting agent, a stabilizing agent, a corrosion inhibitor, a gelling agent, an overcharge inhibitor and a negative electrode film forming agent.

Additionally, the present disclosure relates to a lithium secondary battery comprising a positive electrode, a negative electrode, and the nonaqueous electrolyte solution of the present disclosure interposed between the positive electrode and the negative electrode.

The lithium battery comprising the nonaqueous electrolyte solution of the present disclosure may comprise any positive electrode and negative electrode commonly used in lithium secondary batteries, and may be configured to receive them in a container together with the nonaqueous electrolyte solution of the present disclosure. Additionally, a separator may be interposed between the positive electrode and the negative electrode.

The positive electrode used in the lithium secondary battery of the present disclosure may be manufactured by, for example, coating a positive electrode slurry comprising a positive electrode active material, a binder, a conductive material and a solvent on a positive electrode current collector, drying and roll pressing.

The positive electrode current collector includes any type of positive electrode current collector that has conductivity while not causing a chemical change to the lithium secondary battery of the present disclosure, and may include, for example, stainless steel, aluminum, nickel, titanium, sintered carbon, or aluminum or stainless steel treated with carbon, nickel, titanium and silver on the surface.

The positive electrode active material is a compound capable of reversible intercalation and deintercalation of lithium, and specifically, may comprise a lithium composite metal oxide comprising at least one type of metal of cobalt, manganese, nickel or aluminum and lithium. More specifically, the lithium composite metal oxide may include at least one of lithium-manganese-based oxide (for example, LiMnO₂, LiMn₂O₄), lithium-cobalt-based oxide (for example, LiCoO₂), lithium-nickel-based oxide (for example, LiNiO₂), lithium-nickel-manganese-based oxide (for example, LiNi_{1-y1}Mn_{y1}O₂ (0<y1<1), LiMn_{2-z1}Ni_{z1}O₄ (0<Z1<2)), lithium-nickel-cobalt-based oxide (for example, LiNi_{1-y2}Co_{y2}O₂ (0<y2<1)), lithium-manganese-cobalt-based oxide (for example, LiCo_{1-y3}Mn_{y3}O₂ (0<y3<1), LiMn_{2-z2}Co_{z2}O₄ (0<Z2<2)), lithium-nickel-manganese-cobalt-based oxide (for example, Li(Niₚ₁Co_{q1}Mnᵣ₁)O₂ (0<p1<1, 0<q1<1, 0<r1<1, p1+q1+r1=1), or Li(Niₚ₂Co_{q2}Mnᵣ₂)O₄ (0<p2<2, 0<q2<2, 0<r2<2, p2+q2+r2=2)), or lithium-nickel-cobalt-transition metal (M) oxide (for example, Li(Niₚ₃Co_{q3}Mnᵣ₃M_{S3})O₂ (M is selected from the group consisting of Al, Fe, V, Cr, Ti, Ta, Mg and Mo, and each of p3, q3, r3 and s3 is an atomic ratio of each element, 0<p3<1, 0<q3<1, 0<r3<1, 0<s3<1, p3+q3+r3+s3=1).

The lithium composite metal oxide preferably is preferably lithium composite metal oxide comprising a nickel containing metal and lithium to increase the capacity characteristics and stability of the battery. Specifically, in terms of cost, it is preferred to use lithium-nickel-based oxide (for example, LiNiO₂), lithium-nickel-manganese-cobalt oxide (for example, Li(Ni_{0.6}Mn_{0.2}Co_{0.2})O₂, Li(Ni_{0.5}Mn_{0.3}Co_{0.2})O₂, or Li(Ni_{0.8}Mn_{0.1}Co_{0.1})O₂), or lithium-nickel-cobalt-aluminum oxide (for example, Li(Ni_{0.8}Co_{0.15}Al_{0.05})O₂), and in particular, a nickel-cobalt-manganese (NCM) or nickel-cobalt-aluminum (NCA) ternary material such as lithium-nickel-manganese-cobalt oxide or lithium-nickel-cobalt-aluminum oxide.

The positive electrode active material is preferably included in an amount of 80 to 99 mass % based on the total mass of solids in the positive electrode slurry. When the amount of positive electrode active material is within the above-described range, it is possible to obtain high energy density and capacity.

The binder is used to assist the bond between the positive electrode active material and the conductive material and between the positive electrode active material and the current collector, and is preferably included in an amount of 1 to 30 mass % based on the total mass of solids in the positive electrode slurry. Examples of the binder may include polyvinylidene fluoride, polyvinylalcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene terpolymer (EPDM), sulfonated EPDM, styrene butadiene rubber, and fluorine rubber.

The conductive material imparts conductivity while not causing a chemical change to the lithium secondary battery of the present disclosure, and is preferably included in an amount of 0.5 to 50 mass % based on the total mass of solids in the positive electrode slurry, and more preferably 1 to 20 mass %. When the conductive material is included in the above-described range of amounts, it is possible to improve the electrical conductivity and obtain high energy density and capacity.

The conductive material may include, for example, carbon powder of carbon black, acetylene black, ketjen black, channel black, furnace black, lamp black and thermal black; graphite powder of natural graphite, artificial graphite and graphite with a crystal structure; a conductive fiber such as a carbon fiber and a metal fiber; metal powder such as aluminum and nickel powder; conductive whiskers of zinc oxide and potassium titanate; conductive metal oxide such as titanium oxide; and a conductive material such as polyphenylene derivatives.

The solvent may include any type of solvent capable of making a slurry comprising the positive electrode active material, the binder and the conductive material as the positive electrode material, and may include, for example, an organic solvent such as NMP (N-methyl-2-pyrrolidone), dimethyl formamide (DMF), acetone, dimethylacetamide and water. Additionally, the solvent may be used in such an amount for proper viscosity of the positive electrode slurry, and for example, may be used in such an amount that the concentration of solids in the slurry is 10 mass % to 60 mass %, and preferably 20 mass % to 50 mass %.

The negative electrode used in the lithium secondary battery of the present disclosure may be manufactured by, for example coating a negative electrode slurry comprising a negative electrode active material, a binder, a conductive material and a solvent on a negative electrode current collector, drying and roll pressing.

The negative electrode current collector is generally 3 to 500 μm in thickness. The negative electrode current collector includes any type of negative electrode current collector that has high conductivity while not causing a chemical change to the lithium secondary battery of the present disclosure, and may include, for example, copper, stainless steel, aluminum, nickel, titanium, sintered carbon, copper or stainless steel treated with carbon, nickel, titanium and silver on the surface, an aluminum-cadmium alloy. Additionally, in the same way as the positive electrode current collector, the negative electrode current collector may have fine texture on the surface to increase the bonding of the negative electrode active material, and may be used in various shapes, for example, a film, a sheet, a foil, a net, a porous body, a foam and a nonwoven fabric.

The negative electrode active material may comprise at least one selected from the group consisting of a lithium metal, a carbon material capable of reversible intercalation and deintercalation of a lithium ion, a metal and an alloy of metal and lithium, a metal composite oxide, a material capable of lithium doping and undoping, and a transition metal oxide.

The carbon material capable of reversible intercalation and deintercalation of a lithium ion may include any type of carbon-based negative electrode active material commonly used in lithium secondary batteries, and for example, at least one of crystalline carbon or amorphous carbon. Examples of the crystalline carbon may include amorphous, platy, scaly (flake), spherical or fibrous graphite such as natural graphite and artificial graphite. Examples of the amorphous carbon may include soft carbon (low temperature sintered carbon) or hard carbon, mesophase pitch carbide, and sintered coke.

The metal or the alloy of metal and lithium may include a metal selected from the group consisting of Cu, Ni, Na, K, Rb, Cs, Fr, Be, Mg, Ca, Sr, Si, Sb, Pb, In, Zn, Ba, Ra, Ge, Al and Sn or alloys of these metals and lithium.

The metal composite oxide may be selected from the group consisting of PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, LiₓFe₂O₃ (0≤x≤1), LiₓWO₂ (0≤x≤1) and SnₓMe₁₋ₓMe′_{y}O_{z} (Me: Mn, Fe, Pb, Ge; Me′: A1, B, P, Si, elements in Groups 1, 2 and 3 of the periodic table, halogen; 0<x≤1; 1≤y≤3; 1≤z≤8).

The material capable of lithium doping and undoping may include Si, SiOₓ (0<x<2), Si—Y alloy (Y is at least one selected from the group consisting of alkali metal, alkali earth metal, Group 13 elements, Group 14 elements, transition metal and rare earth elements, and Si is none of them), Sn, SnO₂, Sn—Y (Y is at least one selected from the group consisting of alkali metal, alkali earth metal, Group 13 elements, Group 14 elements, transition metal and rare earth elements, and Sn is none of them), and a mixture of at least one of them and SiO₂. Y may be at least one selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Jr, Pd, Pt, Cu, Ag, Au, Zn, Cd, B, Al, Ga, Sn, In, Ti, Ge, P, As, Sb, Bi, S, Se, Te, and Po.

The transition metal oxide may include lithium containing titanium composite oxide (LTO), vanadium oxide, and lithium vanadium oxide.

The negative electrode active material of the lithium secondary battery of the present disclosure preferably includes a material comprising silicon, and for example, Si, SiOₓ (0<x<2), Si—Y alloy (Y is at least one selected from the group consisting of alkali metal, alkali earth metal, Group 13 elements, Group 14 elements, transition metal, rare earth elements, and Si is none of them), and a mixture of at least one of them and SiO₂. In particular, it is more desirable to use SiO.

The negative electrode active material is preferably included in an amount of 80 to 99 mass % based on the total mass of solids in the negative electrode slurry.

The binder is used to assist the bond between the conductive material, the negative electrode active material and the current collector, and is preferably included in an amount of 1 to 30 mass % based on the total mass of solids in the negative electrode slurry. Examples of the binder may include polyvinylidene fluoride, polyvinylalcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene polymer (EPDM), sulfonated EPDM, styrene butadiene rubber and fluorine rubber.

The conductive material further improves the conductivity of the negative electrode active material, and is preferably included in an amount of 1 to 20 mass % based on the total mass of solids in the negative electrode slurry. The conductive material includes any type of conductive material that has conductivity while not causing a chemical change to the lithium secondary battery, and may include, for example, graphite such as natural graphite and artificial graphite; carbon black such as acetylene black, ketjen black, channel black, furnace black, lamp black and thermal black; a conductive fiber such as a carbon fiber and a metal fiber; metal powder such as aluminum and nickel powder; conductive whiskers of zinc oxide and potassium titanate; conductive metal oxide such as titanium oxide; and conductive polymer such as polyphenylene derivatives.

The solvent includes any type of solvent capable of making a slurry comprising the negative electrode active material, the binder and the conductive material as the negative electrode material, and may include, for example, an organic solvent such as water, NMP and alcohol. Additionally, the solvent may be used in such an amount for proper viscosity of the negative electrode slurry, and for example, may be used in such an amount that the concentration of solids in the slurry is 50 mass % to 75 mass %, preferably 50 mass % to 65 mass %.

The separator of the lithium secondary battery of the present disclosure plays a role in preventing an internal short circuit between the two electrodes and electrolyte wetting, and may be manufactured by mixing a polymer resin, a filler and a solvent to prepare a separator composition, and coating the separator composition directly on the electrode and drying to form a separator film, and may be manufactured by casting the separator composition on a support and drying, and then laminating a separator film separated from the support on the electrode.

The separator may include a porous polymer film commonly used in separators, for example, a porous polymer film made of polyolefin-based polymer such as an ethylene homopolymer, a propylene homopolymer, an ethylene/butene copolymer, an ethylene/hexene copolymer and an ethylene/methacrylate copolymer, as used singly or in stack, or a commonly used porous nonwoven fabric, for example, a nonwoven fabric made of high melting point glass fibers and polyethylene terephthalate fibers, but is not limited thereto.

The pore size of the porous separator is generally 0.01 to 50 μm, and the porosity is 5 to 95%. Additionally, the thickness of the porous separator may generally range 5 to 300 μm.

The charge voltage of the lithium secondary battery of the present disclosure is preferably 4.0V or more, and more preferably 4.1V or more. Additionally, when the lithium secondary battery of the present disclosure is fully charged, the positive electrode potential is preferably 4.0V or more.

Additionally, the initial capacity density per the positive electrode of the lithium secondary battery of the present disclosure is preferably 185 mAh/g or more.

The lithium secondary battery of the present disclosure is not limited to a particular shape, but may be cylindrical, prismatic, pouch-shaped or coin-shaped.

### EXAMPLE

Hereinafter, the present disclosure will be described in more detail using examples and comparative examples, but the scope of the present disclosure is not limited to the examples.

### Example 1

<Manufacture of Positive Electrode>

96.5 parts by weight of nickel-cobalt-manganese (NCM) ternary material (Li(Ni_{0.8}Mn_{0.1}Co_{0.1})O₂) as a positive electrode active material, 1.5 parts by weight of acetylene black as a conductive material, and 2 parts by weight of polyvinylidene fluoride as a binder are dispersed in N-methyl-2-pyrrolidone as a solvent to prepare a positive electrode slurry. The prepared positive electrode slurry is uniformly coated on an aluminum foil, heated and dried in a vacuum, and then pressed to manufacture a positive electrode.

<Manufacture of Negative Electrode>

96 parts by weight of a mixture of graphite and SiO at a ratio of 9:1 as a negative electrode active material, 1.0 part by weight of acetylene black as a conductive material, and 3.0 parts by weight of styrene butadiene rubber and carboxymethyl cellulose as a binder are dispersed in water to prepare a negative electrode slurry. The prepared negative electrode slurry is uniformly coated on a copper foil, heated and dried in a vacuum, and then pressed to manufacture a negative electrode.

<Preparation of Nonaqueous Electrolyte Solution>

A solution is prepared in which 1M LiPF₆ is dissolved in a solvent comprising 30 parts by volume of ethylene carbonate (EC) and 70 parts by volume of ethyl methyl carbonate (EMC). 0.5 parts by weight of bis(dibutyldithiocarbamate)methylene (Sanyo Chemical Industries) (A1) and 0.5 parts by weight of vinylene carbonate are added to 100 parts by weight of the obtained solution to obtain a nonaqueous electrolyte solution of the present disclosure.

<Manufacture of Lithium Secondary Battery>

A pouch-type battery having facing area of 12 cm² is manufactured using the positive electrode, the negative electrode and the nonaqueous electrolyte solution manufactured by the above-described methods and a polyolefin film as a separator.

### Example 2

A nonaqueous electrolyte solution and a lithium secondary battery comprising the same are manufactured by the same method as Example 1 except that instead of bis(dibutyldithiocarbamate)methylene, 2,5-dimercapto-1,3,4-thiadiazole (Sanyo Chemical Industries) (A2) is added to the nonaqueous electrolyte solution.

### Example 3

A nonaqueous electrolyte solution and a lithium secondary battery comprising the same are manufactured by the same method as Example 1 except that instead of bis(dibutyldithiocarbamate)methylene, 1,3,5-Triazine-2,4,6-trithiol (Sanyo Chemical Industries) (A3) is added to the nonaqueous electrolyte solution.

### Example 4

A nonaqueous electrolyte solution and a lithium secondary battery comprising the same are manufactured by the same method as Example 1 except that instead of bis(dibutyldithiocarbamate)methylene, 2-(Dibutylamino)-1,3,5-Triazine-4,6-dithiol (Sanyo Chemical Industries) (A4) is added to the nonaqueous electrolyte solution.

### Example 5

A nonaqueous electrolyte solution and a lithium secondary battery comprising the same are manufactured by the same method as Example 1 except that instead of bis(dibutyldithiocarbamate)methylene, 6-(Diisopropylamino)-1,3,5-triazine-2,4-dithiol (Sanyo Chemical Industries) (A5) is added to the nonaqueous electrolyte solution.

### Example 6

A nonaqueous electrolyte solution and a lithium secondary battery comprising the same are manufactured by the same method as Example 1 except that instead of bis(dibutyldithiocarbamate)methylene, 6-(Diisobutylamino)-1,3,5-triazine-2,4-dithiol (Sanyo Chemical Industries) (A6) is added to the nonaqueous electrolyte solution.

### Example 7

A nonaqueous electrolyte solution and a lithium secondary battery comprising the same are manufactured by the same method as Example 1 except that instead of bis(dibutyldithiocarbamate)methylene, 6-Diallylamino-1,3,5-triazine-2,4-dithiol (Sanyo Chemical Industries) (A7) is added to the nonaqueous electrolyte solution.

### Example 8

A nonaqueous electrolyte solution and a lithium secondary battery are manufactured by the same method as Example 1 except that instead of bis(dibutyldithiocarbamate)methylene, 6-Di(2-ethylhexyl)amino-1,3,5-triazine-2,4-dithiol (Sanyo Chemical Industries) (A8) is added to the nonaqueous electrolyte solution.

### Comparative Example 1

A nonaqueous electrolyte solution and a lithium secondary battery comprising the same are manufactured by the same method as Example 1 except that bis(dibutyldithiocarbamate)methylene is not added to the nonaqueous electrolyte solution.

Evaluation of nonaqueous electrolyte solution and lithium secondary battery

(1) Measurement of Acid Content

A result of measuring the acid content before and after storage of the electrolyte solutions of Examples 1 and 2 at 60° C. for 1 week is shown in the following Table 1. The acid content is measured by putting 10 g of electrolyte solution sample into 100 g of pure water, neutralization and titration using 0.1 mol/L NaOH reagent, and under the assumption that the produced acids are all hydrogen fluoride (HF), calculating the concentration.

TABLE 1

| | | Acid | Acid |
|---|---|---|---|
| | | content | content |
| | | (before | (after |
| | | storage, | storage, |
| | Additive | ppm) | ppm) |
| Example 1 | bis(dibutyldithiocarbamate)methylene | 17.2 | 4.5 |
| Example 2 | 2,5-dimercapto-1,3,4-thiadiazole | 20.4 | 25.5 |
| Comparative | none | 27.1 | 50.5 |
| example 1 | | | |

As can be seen from the result of Table 1, in Examples 1 and 2 using the electrolyte solution comprising bis(dibutyldithiocarbamate)methylene or 2,5-dimercapto-1,3,4-thiadiazole as the nonaqueous electrolyte solution, the amount of acids produced is reduced. Additionally, in particular, in Example 1 using bis(dibutyldithiocarbamate)methylene, the acid content after storage significantly reduces, and thus it can be seen that there is an acid content reduction effect.

(2) Charge/Discharge Cycle Test

A charge/discharge cycle test is performed using the lithium secondary batteries manufactured in Examples 1 to 8 and Comparative example 1 at 45° C. and the constant current of 0.5 C with the upper limit charge voltage of 4.20V and the lower limit discharge voltage of 2.50V. To accurately monitor the capacity in 50th cycle, 100th cycle and 200th cycle, the test is performed using the constant current of 0.1 C.

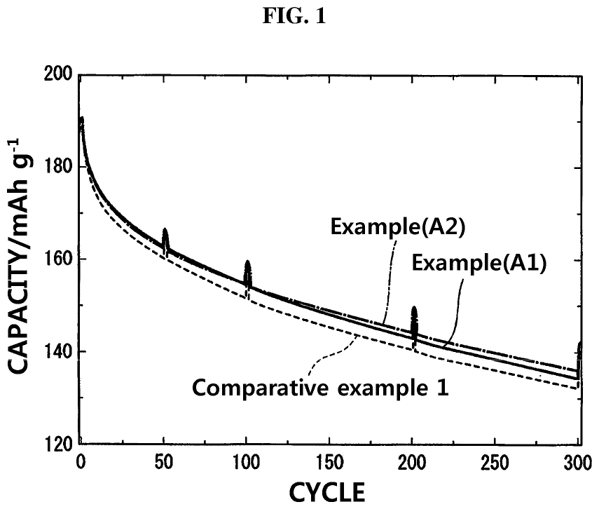

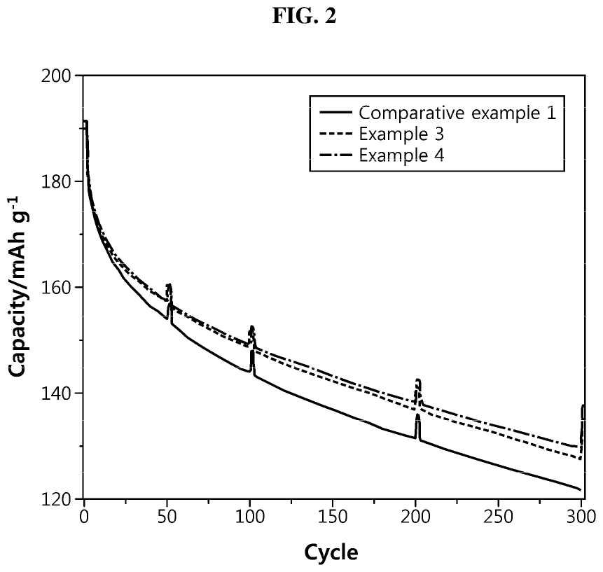

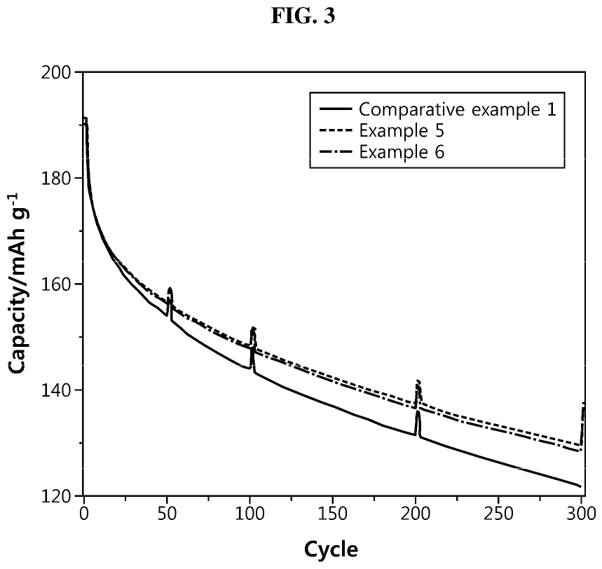

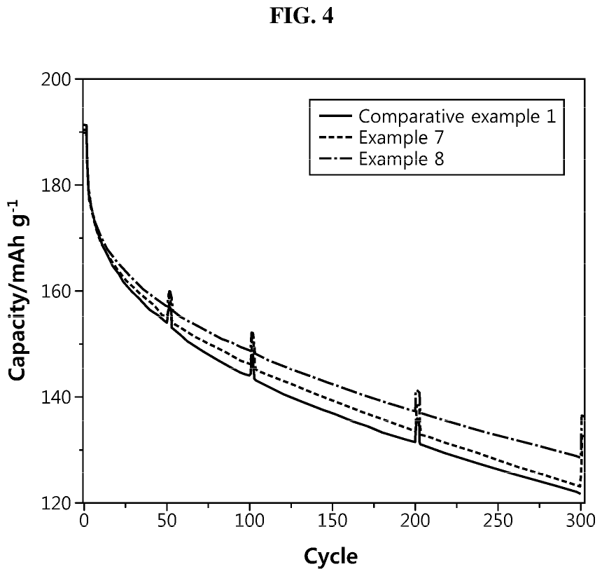

FIGS. 1 to 4 are graphs showing a relationship between cycle number and capacity obtained as a result of the test. In FIG. 1, there is a great difference between Examples 1 and 2 and Comparative example 1 in terms of capacity retention at a relatively early stage, and in the case of Comparative example 1 in which the additive is not added to the nonaqueous electrolyte solution, the capacity significantly reduces. Meanwhile, it can be seen that in the case of Examples 1 and 2 comprising bis(dibutyldithiocarbamate)methylene (A1) or 2,5-dimercapto-1,3,4-thiadiazole (A2) in the nonaqueous electrolyte solution, the capacity is maintained for a long time. It can be seen from FIGS. 2 to 4 that in the case of Comparative example 1 in which the additive is not added to the nonaqueous electrolyte solution, the capacity significantly reduces, while in the case of Examples 3 to 8 respectively comprising 1,3,5-triazine-2,4,6-trithiol, 2-(dibutylamino)-1,3,5-triazine-4,6-dithiol, 6-(diisopropylamino)-1,3,5-triazine-2,4-dithiol, 6-(diisobutylamino)-1,3,5-triazine-2,4-dithiol, 6-diallylamino-1,3,5-triazine-2,4-dithiol, 6-di(2-ethylhexyl)amino-1,3,5-triazine-2,4-dithiol in the nonaqueous electrolyte solution, the capacity is maintained for a long time.

(3) 60° C. Storage Test

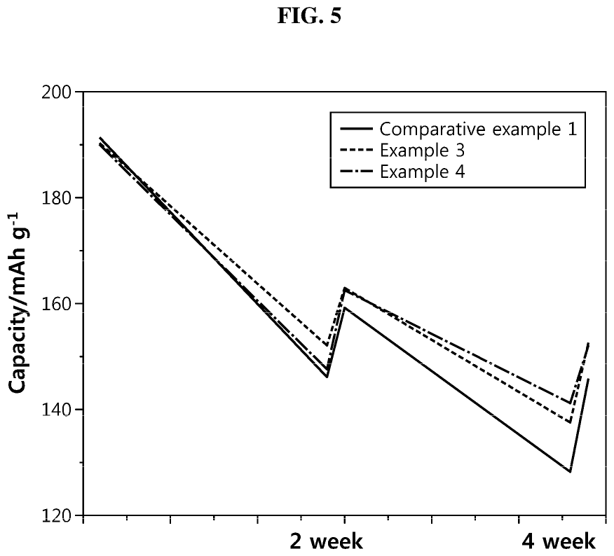

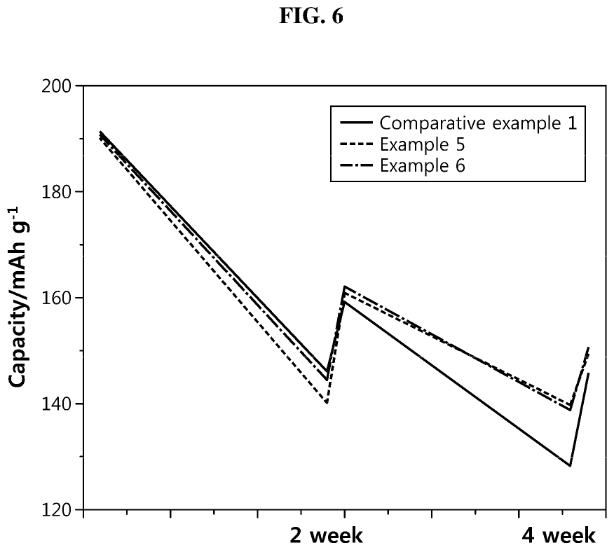

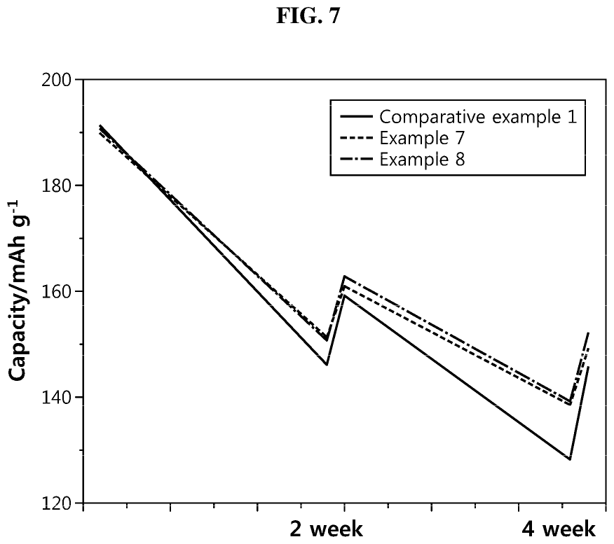

Using the lithium secondary batteries manufactured in Examples 3 to 8 and Comparative example 1, the degree of degradation is evaluated by measuring the discharge capacity at 25° C. and the constant current of 0.5 C with the upper limit charge voltage of 4.2V and the lower limit discharge voltage of 2.50V, and measuring the remaining capacity of the lithium secondary batteries after 2 weeks and 4 weeks after storage in a 60° C. oven in the fully charged state at the constant current of 0.5 C with the upper limit charge voltage of 4.35V. FIGS. 5 to 7 are graphs showing a relationship between cycle number and capacity obtained as a result of the test.

In FIGS. 5 to 7, the capacity dropped immediately after 2 weeks and 4 weeks is “the remaining capacity”. The remaining capacity in 2 weeks rises again due to charging to 4.2V again. That is, the remaining capacity in 4 weeks is a capacity after measuring the remaining capacity in 2 weeks, charging to 4.2V again and storing 60° C. for another 2 weeks.

### INDUSTRIAL APPLICABILITY

The nonaqueous electrolyte solution of the present disclosure suppresses the acid production, thereby maintaining the capacity after the repeated charges/discharges under the high temperature condition.

1. A nonaqueous electrolyte solution, comprising:
a compound comprising 5 to 20 mass % of nitrogen atoms and 25 to 70 mass % of sulfur atoms or oxygen atoms in a molecule and having no disulfide bond in the molecule,
wherein the compound comprises at least two sulfur atoms or oxygen atoms in the molecule.

2. The nonaqueous electrolyte solution according to claim 1,
wherein the compound is a compound comprising 5 to 20 mass % of nitrogen atoms and 25 to 70 mass % of sulfur atoms in the molecule.

3. The nonaqueous electrolyte solution according to claim 1, wherein the compound comprises at least two sulfur atoms in the molecule.

4. The nonaqueous electrolyte solution according to claim 1, wherein the compound comprises at least three sulfur atoms in the molecule.

5. The nonaqueous electrolyte solution according to claim 1, wherein the compound comprises at least one of compounds represented by the following Chemical formulas 1 to 3: 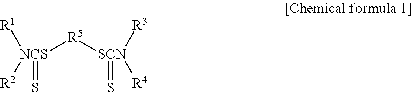
where R₁ is an alkyl group having 1 to 18 carbon atoms or phenyl group, R₂ is an alkyl group having 1 to 18 carbon atoms or phenyl group, R₃ is an alkyl group having 1 to 18 carbon atoms or phenyl group, R₄ is an alkyl group having 1 to 18 carbon atoms or phenyl group, and R₅ is an alkylene group having 1 to 12 carbon atoms, 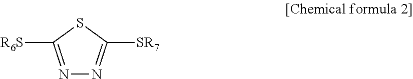
where R₆ is hydrogen, or an alkyl group having 1 to 18 carbon atoms, R₇ is hydrogen, or an alkyl group having 1 to 18 carbon atoms, 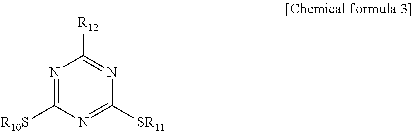
where R₁₀ is hydrogen, or an alkyl group having 1 to 18 carbon atoms, R₁₁ is hydrogen, or an alkyl group having 1 to 18 carbon atoms, R₁₂ is —SR₁₅ or —N(R₁₆)(R₁₇), R₁₅ is hydrogen, or an alkyl group having 1 to 18 carbon atoms, and each of R₁₆ and R₁₇ is independently a substituted or unsubstituted alkyl group having 1 to 18 carbon atoms.

6. The nonaqueous electrolyte solution according to claim 1, wherein the compound comprises at least one of bis(diethylthiocarbamate)methylene, bis(diethyldithiocarbamate)ethylene, bis(dipropylthiocarbamate)methylene, bis(dipropyldithiocarbamate)ethylene, bis(dibutyldithiocarbamate)methylene, bis(dibutyldithiocarbamate)ethylene, bis(dipentyldithiocarbamate)methylene, bis(dipentyldithiocarbamate)ethylene, bis(dihexyldithiocarbamate)methylene, bis(dihexyldithiocarbamate)ethylene 2,5-dimercapto-1,3,4-thiadiazole, 1,3,5-Triazine-2,4,6-trithiol, 2-(Dibutylamino)-1,3,5-Triazine-4,6-dithiol, 6-(Diisopropylamino)-1,3,5-triazine-2,4-dithiol, 6-(Diisobutylamino)-1,3,5-triazine-2,4-dithiol, 6-Diallylamino-1,3,5-triazine-2,4-dithiol or 6-Di(2-ethylhexyl)amino-1,3,5-triazine-2,4-dithiol.

7. The nonaqueous electrolyte solution according to claim 5, wherein the compound comprises at least one of the compound represented by the chemical formula 1 or the compound represented by the chemical formula 3.

8. The nonaqueous electrolyte solution according to claim 1, wherein the compound comprises at least one of bis(diethylthiocarbamate)methylene, bis(diethyldithiocarbamate)ethylene, bis(dipropylthiocarbamate)methylene, bis(dipropyldithiocarbamate)ethylene, bis(dibutyldithiocarbamate)methylene, bis(dibutyldithiocarbamate)ethylene, bis(dipentyldithiocarbamate)methylene, bis(dipentyldithiocarbamate)ethylene, bis(dihexyldithiocarbamate)methylene, bis(dihexyldithiocarbamate)ethylene, 1,3,5-Triazine-2,4,6-trithiol, 2-(Dibutylamino)-1,3,5-Triazine-4,6-dithiol, 6-(Diisopropylamino)-1,3,5-triazine-2,4-dithiol, 6-(Diisobutylamino)-1,3,5-triazine-2,4-dithiol, 6-Diallylamino-1,3,5-triazine-2,4-dithiol or 6-Di(2-ethylhexyl)amino-1,3,5-triazine-2,4-dithiol.

9. The nonaqueous electrolyte solution according to claim 1, wherein the compound is included in an amount of 0.1 to 1 mass % based on the total mass of the nonaqueous electrolyte solution.

10. The nonaqueous electrolyte solution according to claim 1, wherein the nonaqueous electrolyte solution further comprises a cyclic carbonate and a chain carbonate.

11. The nonaqueous electrolyte solution according to claim 1, wherein the nonaqueous electrolyte solution further comprises a lithium salt.

12. The nonaqueous electrolyte solution according to claim 11, wherein the lithium salt is LiPF₆.

13. A lithium secondary battery, comprising:
a positive electrode, a negative electrode, and the nonaqueous electrolyte solution according to claim 1 interposed between the positive electrode and the negative electrode.

14. The lithium secondary battery according to claim 13, wherein the positive electrode comprises a nickel-cobalt-manganese (NCM) or nickel-cobalt-aluminum (NCA) ternary material.

15. The lithium secondary battery according to claim 13, wherein the negative electrode comprises a material comprising silicon.

16. The lithium secondary battery according to claim 13, wherein an initial capacity density per the positive electrode is 185 mAh/g or more.

17. The nonaqueous electrolyte solution according to claim 1, wherein a mass ratio of the nitrogen atoms and the sulfur atoms or the oxygen atoms in the molecule of the compound is 5:1 to 1:10.

18. The lithium secondary battery according to claim 15, wherein the material comprising silicon is SiO.

19. The lithium secondary battery according to claim 15, which has a charge voltage of 4.0V or more.
